(19) United States
(12) Patent Application Publication
(10) Pub. No.: US 2026/0088380 A1
(43) Pub. Date: Mar. 26, 2026

(54) TEMPERATURE ACQUISITION ASSEMBLY AND BATTERY

(71) Applicant: EVE ENERGY CO., LTD., Huizhou (CN)

(72) Inventors: Chaoju REN, Huizhou (CN); Yi HUANG, Huizhou (CN); Guojiang ZHANG, Huizhou (CN)

(73) Assignee: EVE ENERGY CO., LTD., Huizhou (CN)

(21) Appl. No.: 19/336,150

(22) Filed: Sep. 22, 2025

(30) Foreign Application Priority Data
Dec. 25, 2024 (CN) PCT/CN2024/142243
Sep. 20, 2024 (CN) 202411322217.4

(51) Int. Cl. H01M 10/48; G01K 1/14; G01K 1/16; H01M 50/107

(52) U.S. Cl. CPC H01M 10/486; G01K 1/14; G01K 1/16; H01M 50/107

(57) ABSTRACT

The present application discloses a temperature acquisition assembly and a battery. The temperature acquisition assembly is arranged on the battery and comprises a housing and at least one measuring member. A surface of the housing is pressed against the cell, the surface is provided with a groove, and the measuring member is arranged in the groove and in contact with the cell.

This application claims the priority to Application of PCT/CN2024/142243, filed on December 25, 2024, which claims priority to Chinese Application No. 202411322217.4, filed on September 20, 2024, the contents of which are incorporated herein by reference in their entirety.

### TECHNICAL FIELD

The present application relates to the technical field of batteries, and more particularly to a temperature acquisition assembly and a battery.

### BACKGROUND

Temperature acquisition of a battery is an important part of a Battery Management System (BMS), and its accuracy directly affects the safety and service life of the battery.

In related technologies, temperature acquisition of a cell (e.g., a cylindrical cell) is performed using a water-drop-type NTC (Negative Temperature Coefficient) thermistor.

### SUMMARY

However, the water-drop-type NTC is encapsulated with epoxy resin, resulting in a relatively long thermal time constant and poor acquisition accuracy. In addition, the water-drop-type NTC generally presents an arcuate shape, which forms a linear contact when placed on the surface of the cell. This not only leads to poor stability but also causes a significant deviation between the acquired cell temperature and the actual temperature, failing to accurately reflect the true temperature of the cell.

In a first aspect, the present application provides a temperature acquisition assembly, comprising: a housing, a surface of the housing is pressed against a cell, and the surface of the housing is provided with a groove; and at least one measuring member, arranged in the groove and in contact with the cell.

In a second aspect, the present application further provides a battery, comprising: a cell and the temperature acquisition assembly provided in the first aspect, the temperature acquisition assembly is pressed against a side surface of the cell.

The battery of the present application is equipped with a temperature acquisition assembly. The temperature acquisition assembly includes a housing and at least one measuring member. The housing has a surface pressed against the cell, and the surface is provided with a groove. The measuring member is arranged in the groove and is in contact with the cell. Moreover, the measuring member for acquiring the temperature of the cell can not only be firmly fixed to the cell, but can also contact the cell directly, thereby enabling accurate temperature acquisition of the cell and greatly improving the accuracy of the temperature acquisition of the cell.

### DESCRIPTION OF DRAWINGS

FIG. 1 is a connection diagram of the temperature acquisition assembly and the cell of the present application;

FIG. 2 is a schematic structural diagram of the temperature acquisition assembly of the present application;

FIG. 3 is an exploded view of the temperature acquisition assembly of the present application;

FIG. 4 is a schematic structural diagram of the measuring member and the electrical connecting member of the present application;

FIG. 5 is another schematic structural diagram of the measuring member and the electrical connecting member of the present application;

FIG. 6 is a schematic structural diagram of the measuring member on the flexible circuit board of the present application;

FIG. 7 is a schematic structural diagram of the connecting member of the present application;

FIG. 8 is a schematic structural diagram of the housing of the present application;

FIG. 9 is another schematic structural diagram of the housing of the present application;

FIG. 10 is a schematic structural diagram of the third reinforcement member of the present application;

FIG. 11 is a schematic structural diagram of the connector of the present application;

FIG. 12 is a schematic structural diagram of the heat-conducting member of the present application.

### Description of Reference Numerals

10 – cell; 210 – housing; 211 – groove; 212 – second opening; 220 – measuring member; 221 – first thermistor; 222 – second thermistor; 230 – connecting member; 231 – first opening; 240 – heat-conducting member; 250 – electrical connecting member; 251 – flexible circuit board; 2511 – first connecting portion; 2512 – second connecting portion; 252 – connector; 2521 – connecting point; 260 – first reinforcement member; 270 – second reinforcement member; 280 – sealing member; 290 – third reinforcement member; 291 – third opening.

### DETAILED DESCRIPTION

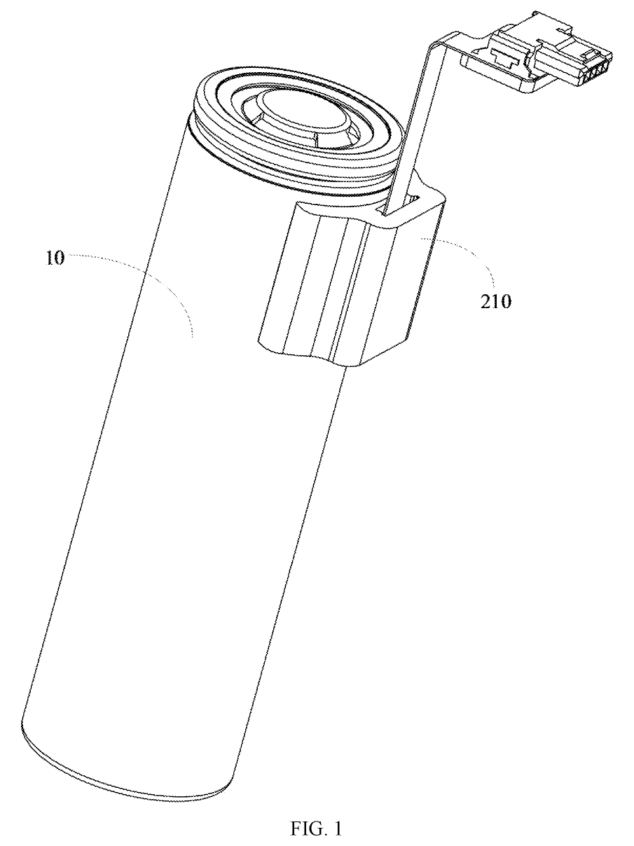

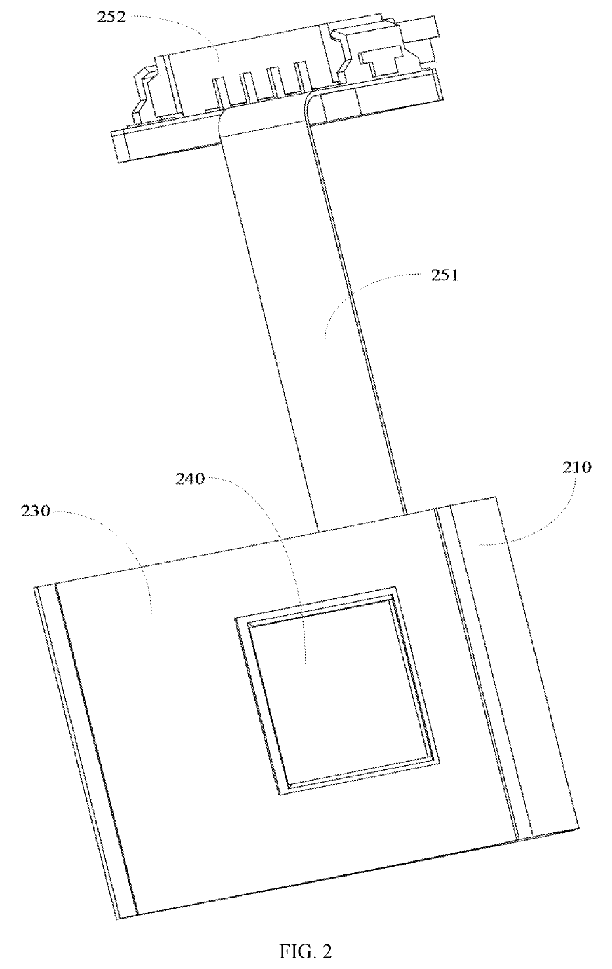

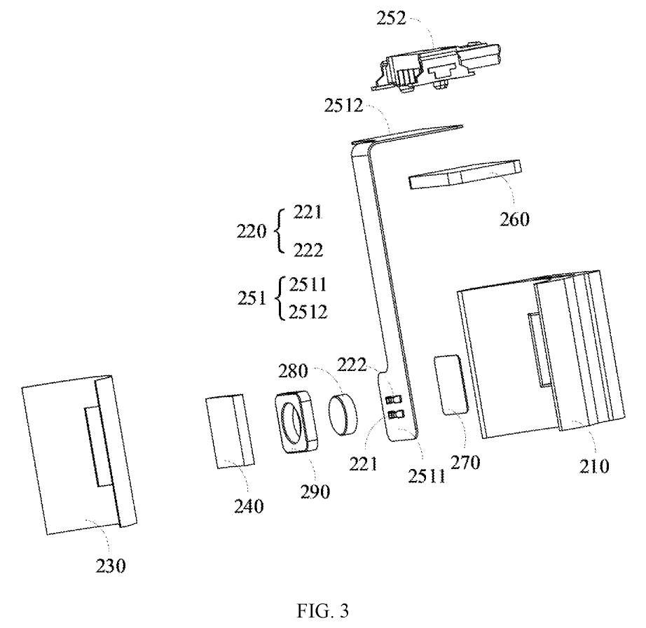

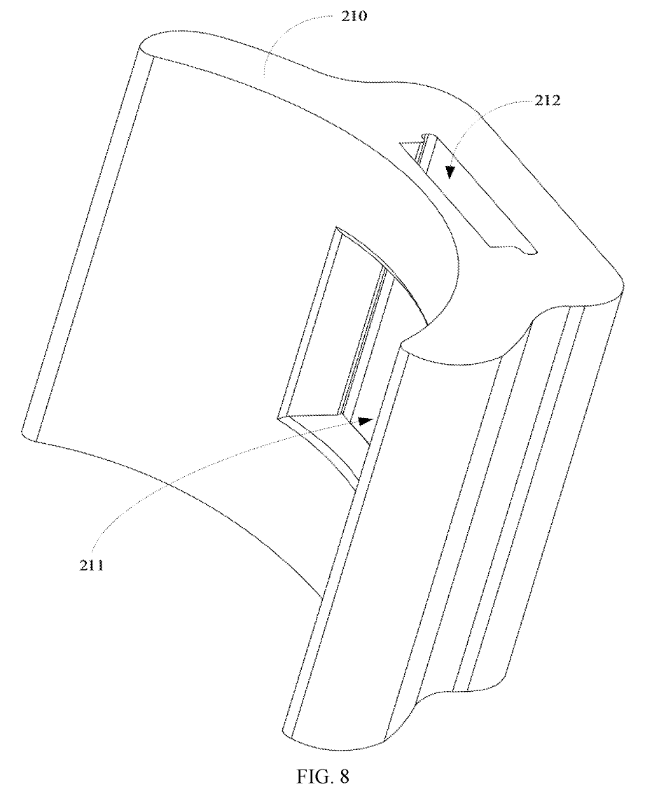

Refer to FIG. 1, FIG. 2, FIG. 3 and FIG. 8. FIG. 1 is a connection diagram of the temperature acquisition assembly and the cell 10 of the present application; FIG. 2 is a schematic structural diagram of the temperature acquisition assembly of the present application; FIG. 3 is an exploded view of the temperature acquisition assembly of the present application; FIG. 8 is a schematic structural diagram of the housing 210 of the present application.

As shown in FIG. 1, FIG. 2, FIG. 3 and FIG. 8, the present application provides a temperature acquisition assembly, comprising: a housing 210, a surface of the housing 210 is pressed against the cell 10, and the surface of the housing 210 is provided with a groove 211; and at least one measuring member 220, arranged in the groove 211 and in contact with the cell 10.

In this embodiment, the cell 10 may be a cylindrical cell. When the housing 210 is attached and fixed to the cell 10, the surface of the housing 210 for attachment to the cell 10 needs to be set according to the attachment position, which not only simplifies the fixing process of the temperature acquisition assembly, but also enables firm attachment to the cell 10.

Exemplarily, when the housing 210 is attached and fixed to a side surface of the cylindrical cell, since the side surface of the cylindrical cell is a curved surface, the surface of the housing 210, that is, the attachment surface, may be formed as a curved surface, thereby allowing the housing 210 to be closely and reliably pressed against the side surface of the cylindrical cell. When the housing 210 is pressed against a side surface of a prismatic cell, since the side surface of the prismatic cell is a flat surface, the surface of the housing 210, that is, the attachment surface, may be formed as a flat surface, which similarly enables the housing 210 to be closely and reliably pressed against the side surface of the prismatic cell.

It should be noted that the housing 210 may also be attached and fixed to an upper end surface or a lower end surface of the cell 10.

In some embodiments, since the side surface temperature of the cell 10 is closest to the internal temperature of the cell 10, the housing 210 may preferably be attached and fixed to the side surface of the cell 10.

Specifically, the measuring member 220 may be an NTC thermistor, and the temperature acquisition assembly composed of the measuring member 220 and the housing 210 may be understood as a patch-type NTC.

In order to accurately acquire the temperature of the cell 10, the surface of the housing 210 that is attached and fixed to the cell 10 is provided with a groove 211, and the measuring member 220 may be arranged in the groove 211. When the housing 210 is attached and fixed to the cell 10, the measuring member 220 can be in contact with the cell 10 within the groove 211, which not only prevents the measuring member 220 from being exposed to the external environment, but also enables accurate acquisition of the temperature of the cell 10.

It should also be noted that, in order to improve the accuracy of temperature acquisition of the cell 10, the housing 210 may further be provided with multiple grooves 211 on the surface attached and fixed to the cell 10, with one measuring member 220 arranged in each groove 211, or the housing 210 may be provided with one groove 211 on the surface attached and fixed to the cell 10, and multiple measuring members 220 may be arranged in the groove 211.

It can be understood that the number of grooves 211 provided on the surface of the housing 210 attached and fixed to the cell 10, and the number of measuring members 220 in the temperature acquisition assembly, may be selected according to actual applications, and no specific limitation is imposed by the present application.

The temperature acquisition assembly of the present application includes the housing 210 and at least one measuring member 220. A surface of the housing 210 is pressed against the cell 10, the surface is provided with a groove 211, the measuring member 220 is arranged in the groove 211 and is in contact with the cell 10. Thus, the measuring member 220, which acquires the temperature of the cell 10, can not only be firmly fixed to the cell 10, but also be in contact with the cell 10, thereby accurately acquiring the temperature of the cell 10 and greatly improving the accuracy of temperature acquisition of the cell 10.

Moreover, compared with the NTC of a water-drop probe, the maximum acquisition deviation of the NTC of the water-drop probe can only reach 1%, while the acquisition deviation of the temperature acquisition assembly of the present application can reach 0.5%, which greatly improves the accuracy of temperature acquisition.

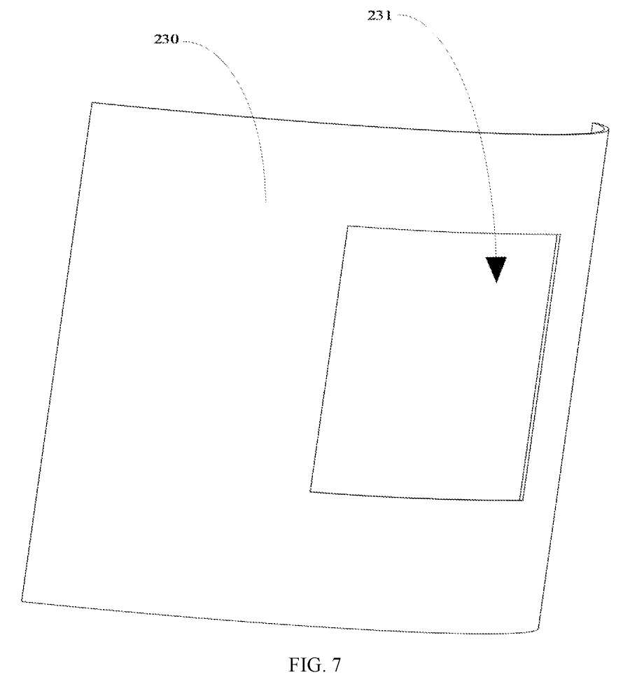

In some embodiments, as shown in FIG. 2, FIG. 3, and FIG. 7, the temperature acquisition assembly further includes a connecting member 230; wherein the connecting member 230 has one side surface pressed against the cell 10, and has another surface pressed against a surface of the housing 210.

In the present embodiment, the housing 210 is attached and fixed to the cell 10 by means of the connecting member 230, which may be a double-sided adhesive tape. One side of the double-sided adhesive tape may be adhered to a side surface of the cell 10, and another side may be adhered to a surface of the housing 210, thereby achieving the attachment and fixation of the housing 210 to the cell 10.

Wherein, in order to ensure proper selection, the double-sided adhesive tape is required to have high resistance to high temperatures and low temperatures, so as to ensure that the housing 210 can be stably pressed against the side surface of the cell 10. This can solve problems such as difficulty in installing the temperature acquisition assembly and low production efficiency, thereby greatly improving production efficiency.

In some embodiments, as shown in FIG. 2, FIG. 3, and FIG. 7, the connecting member 230 is provided with a first opening 231, and the first opening 231 is matched with the groove 211.

In the present embodiment, in order to prevent the connection member 230 from interfering with the temperature acquisition of the measuring member 220, the connecting member 230 is further provided with an opening, namely the first opening 231, to avoid the measuring member 220, so that the temperature of the side surface of the cell 10 can be accurately transferred to the measuring member 220, thereby improving the accuracy of temperature acquisition of the cell 10.

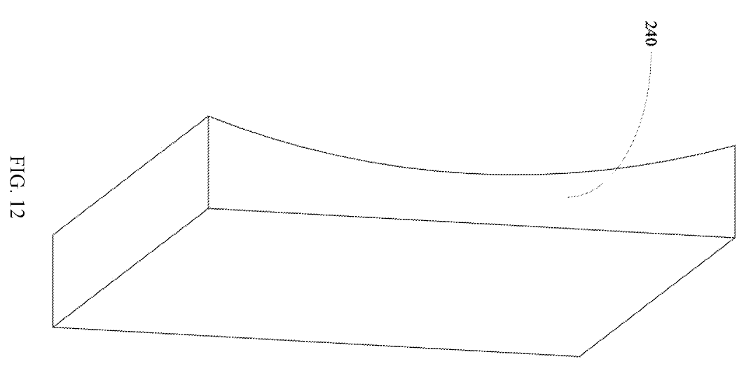

In some embodiments, as shown in FIG. 2, FIG. 3, and FIG. 12, the temperature acquisition assembly further includes a heat-conducting member 240; wherein the heat-conducting member 240 is arranged in the groove 211, one side surface of the heat-conducting member 240 is in contact with the cell 10, and another side surface of the heat-conducting member 240 is in contact with the measuring member 220.

In the present embodiment, in order to accurately acquire the temperature of the cell 10, a heat-conducting member 240 may also be arranged between the measuring member 220 and the cell 10 and be configured to transfer the temperature between the cell 10 and the measuring member 220. The heat-conducting member 240 may be a thermal conductive adhesive, which has a high thermal conductivity coefficient and also possesses elasticity, enabling rapid transfer of the temperature of the cell 10 to the measuring member 220. The thermal conductive adhesive may have a shape matching the structure of the cell 10 and may protrude beyond a preset thickness of the housing 210, such as 0.2 mm, thereby ensuring that there is no gap between the measuring member 220 and the cell 10, and improving the accuracy of temperature acquisition.

It should be noted that the heat-conducting member 240 may also cover the groove 211, that is, a part of the heat-conducting member 240 is arranged in the groove 211, and another part is arranged between the housing 210 and the cell 10. The structure of the heat-conducting member 240 may be selected according to actual applications, and no specific limitation is imposed by the present application.

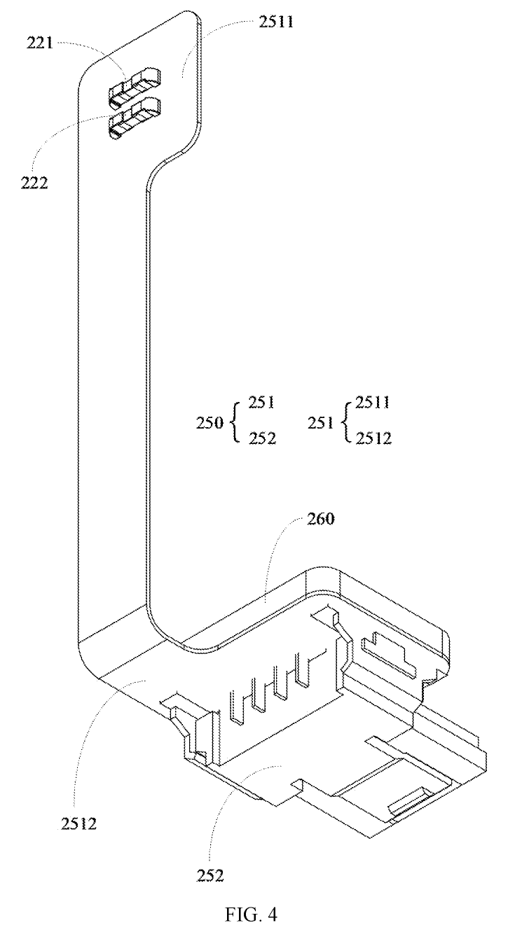

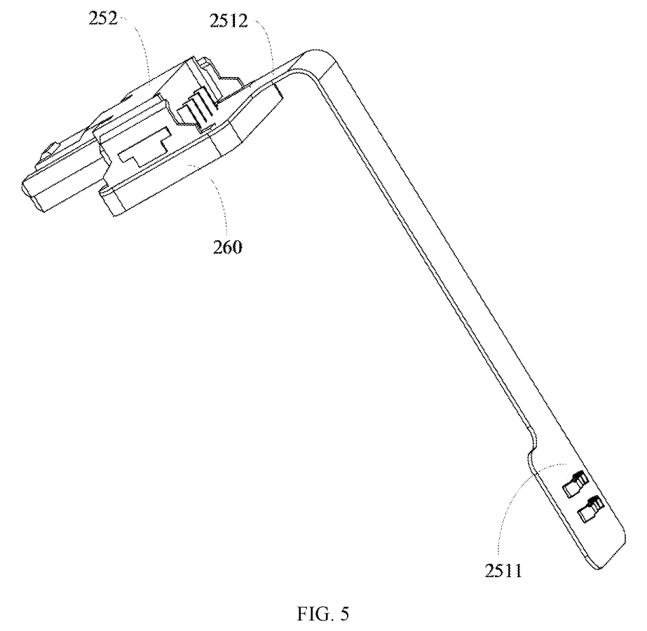

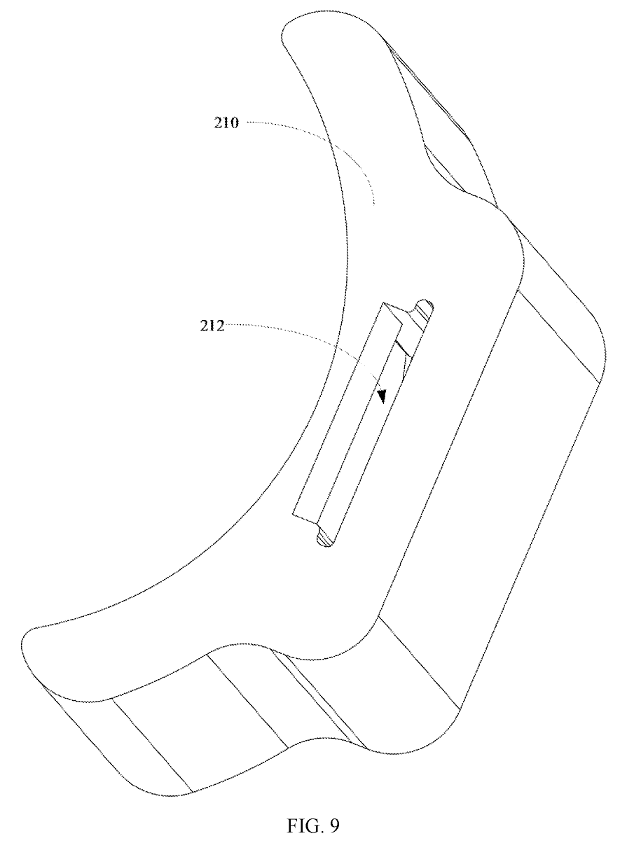

In some embodiments, as shown in FIG. 2, FIG. 3, FIG. 4, FIG. 5, FIG. 8, and FIG. 9, the temperature acquisition assembly further includes an electrical connecting member 250; wherein the housing 210 is provided with a second opening 212, and the second opening 212 communicates with the groove 211; one end of the electrical connecting member 250 electrically connects the measuring member 220 through the second opening 212, and the other end of the electrical connecting member 250 electrically connects a target device.

Specifically, in order to facilitate the electrical connection of the measuring member 220 with a master control board and/or a slave control board of a battery management system, an opening, namely the second opening 212, needs to be provided on the housing 210. The second opening 212 needs to communicate with the groove 211, so that the electrical connecting member 250 for electrically connecting the measuring member 220 with a target device can enter the groove 211 through the second opening 212 and electrically connect to the measuring member 220. The target device may be understood as the master control board or the slave control board of the battery management system.

Moreover, the position of the second opening 212 on the housing 210 may be arranged in a vertical direction or in a horizontal direction. It should be noted that the position of the second opening 212 can be set according to the arrangement of the cell 10 in the battery module, and no specific limitation is imposed by the present application.

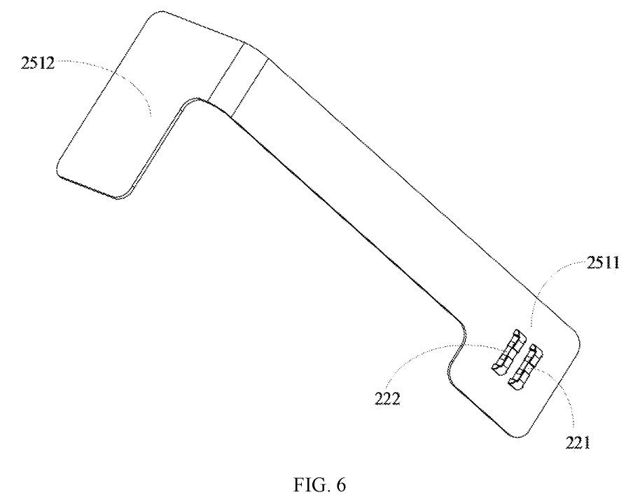

In some embodiments, as shown in FIG. 2, FIG. 3, FIG. 4, FIG. 5, FIG. 6, FIG. 8, and FIG. 9, the electrical connecting member 250 includes a flexible circuit board 251 and a connector 252; wherein the flexible circuit board 251 includes a bent first connecting portion 2511 and a second connecting portion 2512, the first connecting portion 2511 electrically connects the measuring member 220 through the second opening 212, the second connecting portion 2512 electrically connects the connector 252, and the connector 252 electrically connects a target device.

In the present embodiment, the electrical connecting member 250 may be composed of the flexible circuit board 251 and the connector 252. The flexible circuit board 251 includes the first connecting portion 2511 and the second connecting portion 2512. The first connecting portion 2511 passes through the second opening 212 to electrically connect the measuring member 220, and the second connecting portion 2512 electrically connects the target device through the connector 252. The first connecting portion 2511 and the second connecting portion 2512 may be integrally formed to constitute the flexible circuit board 251, and the first connecting portion 2511 and the second connecting portion 2512 may be bent relative to each other.

Moreover, the connector 252 is configured for signal transmission, facilitating the transmission of signals acquired by the measuring member 220, and the connector 252 can be directly connected to a main control board or a subordinate control board of a battery management system.

It should be noted that the bending manner between the first connecting portion 2511 and the second connecting portion 2512 can be selected according to the arrangement of the cell 10 in the battery module, and no specific limitation is imposed by the present application.

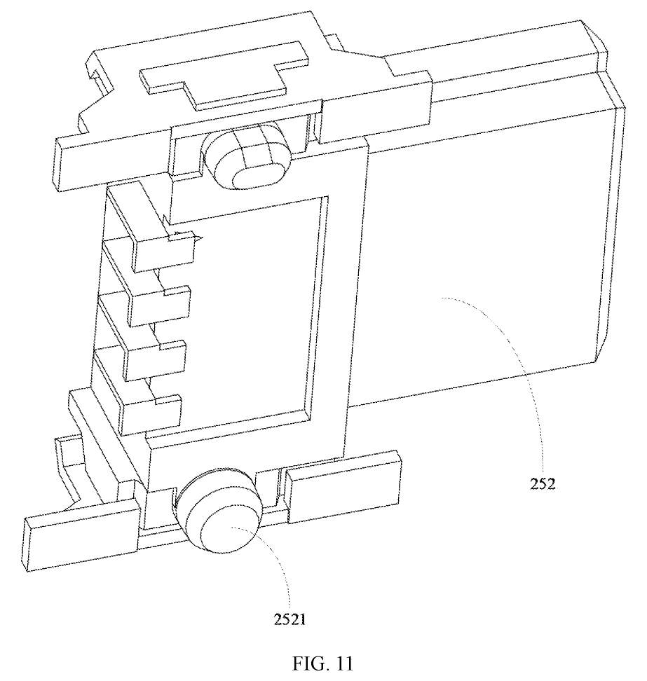

In some embodiments, as shown in FIG. 3, FIG. 4, FIG. 5 and FIG. 11, the temperature acquisition assembly further includes a first reinforcement member 260; Moreover, the first reinforcement member 260 is configured to fix the second connecting portion 2512 to the connector 252.

In the present embodiment, the first reinforcement member 260 may be a reinforcement plate, which can fix the flexible circuit board 251 to the connector 252 after the flexible circuit board 251 and the connector 252 are electrically connected.

Specifically, the connector 252 is provided with two connecting points 2521. After the flexible circuit board 251 is electrically connected to the connector 252, the first reinforcing member 260 can be fixedly connected to the connecting points 2521 to fix the second connecting portion 2512 between the first reinforcing member 260 and the connector 252.

In some embodiments, as shown in FIG. 3, the temperature acquisition assembly further includes a second reinforcing member 270; in which one surface of the second reinforcing member 270 is in contact with the first connecting portion 2511, and another surface of the second reinforcing member 270 is in contact with a bottom of the groove 211.

Specifically, the measuring member 220 may be electrically connected to the flexible circuit board 251 by welding. After the measuring member 220 is welded to the flexible circuit board 251, in order to prevent a welding point on the first connecting portion 2511 from being damaged by compression from the bottom of the groove 211, a second reinforcing member 270 is further provided between the welding point and the bottom of the groove 211, that is, the second reinforcing member 270 is arranged between the first connecting portion 2511 and the bottom of the groove 211. The second reinforcing member 270 may be a reinforcing plate.

In some embodiments, as shown in FIG. 3, FIG. 4, FIG. 5, and FIG. 6, the measuring member 220 includes a first thermistor 221 and a second thermistor 222; in which the first thermistor 221 and the second thermistor 222 are both configured to perform temperature measurement of the cell 10.

In the present embodiment, the measuring member 220 may include two thermistors, namely the first thermistor 221 and the second thermistor 222. The first thermistor 221 and the second thermistor 222 may both be welded to the flexible circuit board 251 and arranged in parallel, thereby not only enabling mutual verification of the acquired temperatures, but also ensuring that if one thermistor fails, the other thermistor can still acquire the temperature of the cell 10, so that real-time and accurate temperature acquisition can be performed throughout the full life cycle of the cell 10.

In some embodiments, as shown in FIG. 3, the temperature acquisition assembly further includes a sealing member 280. The sealing member 280 is arranged between the measuring member 220 and the cell 10 and is configured to seal the measuring member 220.

In the present embodiment, the measuring member 220 may be embedded in the sealing member 280, thereby preventing the measuring member 220 from being damaged by impact and also preventing moisture from corroding the measuring member 220. Specifically, after the measuring member 220 is welded to the first connecting portion 2511 of the flexible circuit board 251, the sealing member 280 can directly seal the measuring member 220.

The sealing member 280 may be a UV adhesive, which is also known as ultraviolet curing adhesive, shadowless adhesive, or photosensitive adhesive, and is a one-component modified acrylate adhesive. The UV adhesive can be cured by ultraviolet irradiation.

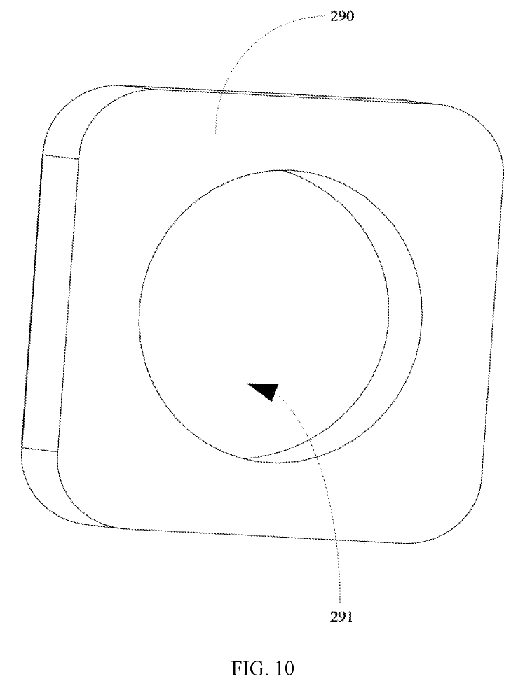

In some embodiments, as shown in FIG. 3 and FIG. 10, the temperature acquisition assembly further includes a third reinforcing member 290; in which the third reinforcing member 290 is provided with a third opening 291, and the measuring member 220 is arranged within the third opening 291.

In the present embodiment, the third reinforcing member 290 is arranged between the heat-conducting member 240 and the first connecting portion 2511. The third reinforcing member 290 may be a reinforcing plate, and the third reinforcing plate is provided with the third opening 291. The third opening 291 may be a circular through hole, and the sealing member 280 may be filled in the third opening 291, thereby serving to ensure the height of the sealing member 280 and also preventing the measuring member 220 from being damaged during installation and use.

It should be noted that the shape of the third opening 291 may also be rectangular or triangular, and the specific shape may be selected according to actual applications. No specific limitation is imposed by the present application.

In some embodiments, the present application also provides a battery comprising a cell 10 and the temperature acquisition assembly provided by the present application. The temperature acquisition assembly is pressed against a side surface of the cell 10.

In the present embodiment, the battery includes a battery module and the temperature acquisition assembly. The battery module includes multiple cells 10 arranged side by side, and the temperature acquisition assembly is configured to acquire the temperature of the cells 10 and transmit the acquired temperature to a battery management system, so as to accurately monitor the real-time temperature of the cells 10.

The battery may be a large cylindrical battery, and the cell 10 of the large cylindrical battery may be a cylindrical cell.

1. A temperature acquisition assembly, comprising:
a housing, having a surface to be pressed against a cell, the surface being provided with a groove; and
at least one measuring member arranged in the groove and in contact with the cell.

2. The temperature acquisition assembly of claim 1, further comprising:
a connecting member;
wherein one side surface of the connecting member is pressed against the cell, and another side surface of the connecting member is pressed against a surface of the housing.

3. The temperature acquisition assembly of claim 2, wherein the connecting member is provided with a first opening, and the first opening is matched with the groove.

4. The temperature acquisition assembly of claim 1, further comprising:
a heat-conducting member;
wherein the heat-conducting member is arranged in the groove, one side surface of the heat-conducting member is in contact with the cell, and another side surface of the heat-conducting member is in contact with the measuring member.

5. The temperature acquisition assembly of claim 1, further comprising:
an electrical connecting member;
wherein the housing is provided with a second opening, the second opening communicates with the groove; one end of the electrical connecting member electrically connects the measuring member through the second opening, and the other end of the electrical connecting member electrically connects a target device.

6. The temperature acquisition assembly of claim 5, wherein the electrical connecting member comprises:
a flexible circuit board and a connector;
wherein the flexible circuit board comprises a bent first connecting portion and a second connecting portion, the first connecting portion electrically connects the measuring member through the second opening, the second connecting portion electrically connects the connector, and the connector electrically connects the target device.

7. The temperature acquisition assembly of claim 6, further comprising:
a first reinforcement member;
wherein the first reinforcement member is configured to fix the second connecting portion to the connector.

8. The temperature acquisition assembly of claim 6, further comprising:
a second reinforcement member;
wherein one surface of the second reinforcement member is in contact with the first connecting portion, and another surface of the second reinforcement member is in contact with a bottom of the groove.

9. The temperature acquisition assembly of claim 1, wherein the measuring member comprises:
a first thermistor and a second thermistor;
wherein the first thermistor and the second thermistor are configured to perform temperature measurement of the cell.

10. The temperature acquisition assembly of claim 1, further comprising:
a sealing member, the sealing member is arranged between the measuring member and the cell, and the sealing member is configured to seal the measuring member.

11. The temperature acquisition assembly of claim 1, further comprising:
a third reinforcement member;
wherein the third reinforcement member is provided with a third opening, and the measuring member is arranged within the third opening.

12. The temperature acquisition assembly of claim 2, further comprising:
a heat-conducting member;
wherein the heat-conducting member is arranged in the groove, one side surface of the heat-conducting member is in contact with the cell, and another side surface of the heat-conducting member is in contact with the measuring member.

13. The temperature acquisition assembly of claim 3, further comprising:
a heat-conducting member;
wherein the heat-conducting member is arranged in the groove, one side surface of the heat-conducting member is in contact with the cell, and another side surface of the heat-conducting member is in contact with the measuring member.

14. The temperature acquisition assembly of claim 2, further comprising:
an electrical connecting member;
wherein the housing is provided with a second opening, the second opening communicates with the groove; one end of the electrical connecting member electrically connects the measuring member through the second opening, and the other end of the electrical connecting member electrically connects a target device.

15. The temperature acquisition assembly of claim 3, further comprising:
an electrical connecting member;
wherein the housing is provided with a second opening, the second opening communicates with the groove; one end of the electrical connecting member electrically connects the measuring member through the second opening, and the other end of the electrical connecting member electrically connects a target device.

16. The temperature acquisition assembly of claim 4, further comprising:
an electrical connecting member;
wherein the housing is provided with a second opening, the second opening communicates with the groove; one end of the electrical connecting member electrically connects the measuring member through the second opening, and the other end of the electrical connecting member electrically connects a target device.

17. The temperature acquisition assembly of claim 2, wherein the measuring member comprises:
a first thermistor and a second thermistor;
wherein the first thermistor and the second thermistor are configured to perform temperature measurement of the cell.

18. The temperature acquisition assembly of claim 3, wherein the measuring member comprises:
a first thermistor and a second thermistor;
wherein the first thermistor and the second thermistor are configured to perform temperature measurement of the cell.

19. The temperature acquisition assembly of claim 4, wherein the measuring member comprises:
a first thermistor and a second thermistor;
wherein the first thermistor and the second thermistor are configured to perform temperature measurement of the cell.

20. A battery, comprising:
a cell, and the temperature acquisition assembly of claim 1, the temperature acquisition assembly is pressed against a side surface of the cell.
